(19) United States
(12) Patent Application Publication
(10) Pub. No.: US 2013/0309442 A1
(43) Pub. Date: Nov. 21, 2013

(54) Structural Member with Locally Reinforced Portion and Method for Forming Structural Member

(71) Applicant: TICONA LLC, Florence, KY (US)

(72) Inventors: Michael Ruby, Cincinnati, OH (US); David Eastep, Winona, MN (US); Daniel Grauer, Bretten (DE)

(73) Assignee: Ticona LLC, Florence, KY (US)

(21) Appl. No.: 13/893,434

(22) Filed: May 14, 2013

Related U.S. Application Data
(60) Provisional application No. 61/648,389, filed on May 17, 2012.

(51) Int. Cl. B62D 25/00; B32B 5/12; B32B 27/08; B32B 7/02; B29C 70/02; B32B 17/04

(52) U.S. Cl. CPC B62D 25/00; B29C 70/023; B32B 17/04; B32B 27/08; B32B 7/02; B32B 5/12
USPC 428/109; 264/257; 264/258; 428/428; 428/212; 428/213; 428/221; 442/239; 428/172

(57) ABSTRACT

Structural members and methods for forming structural members are provided. A structural member includes a body portion and a locally reinforced portion. The body portion is formed from a long fiber thermoplastic material, the long fiber thermoplastic material including a plurality of long fibers dispersed in a thermoplastic resin. The locally reinforced portion is formed from a continuous fiber thermoplastic material overmolded by the long fiber thermoplastic material, the continuous fiber thermoplastic material including a plurality of continuous fibers dispersed in a thermoplastic resin.

### CROSS REFERENCE TO RELATED APPLICATION

The present application claims filing benefit of U.S. Provisional Patent Application Ser. No. 61/648,389 having a filing date of May 17, 2012 which is incorporated herein by reference in its entirety.

### BACKGROUND OF THE INVENTION

Reducing mass while maintaining structural integrity is an important consideration in many industries. For example, the automotive industry is presently working to meet pending fuel economy and emission requirements. One factor in accomplishing these goals is the mass and structural integrity of various automotive components. The addition of, for example, safety equipment, convenience items, and onboard electronics has increased the weight of the average automobile. Alternative propulsion systems which seek to reduce emissions, such as hybrid-electric systems, fuel cells, and electric-drive systems, have further increased this weight. This leads to losses in fuel economy due to efforts to reduce emissions.

In an effort to reduce mass, many industries, including the automotive industry, are investigating the use of composite materials. For example, many automotive components that were initially made from metal have been replaced with composite components. Sheet molding compounds and glass mat thermoplastics were originally utilized. These materials were lighter than, for example, steel and aluminum. In turn, these materials were replaced with lightweight reinforced thermoplastics, and more recently with long fiber thermoplastics. These materials have further reduced the weight of the subject components.

However, these previously utilized composite materials in many cases have proven to not be as stiff or durable, or have the desired structural integrity, required for various applications. This is of particular concern in the automotive industry. One particular automotive component of concern is the underbody shield for an automobile. Due to the challenges presented by exposure of the underbody shield during operation of an automobile, the underbody shield must have suitable structural integrity for these applications. Presently utilized materials may not provide such integrity.

As such, a need exists for an improved structural member, and in particular an improved automotive structural member, such as an automobile underbody shield, A structural member that is lightweight while maintaining suitable structural integrity for a desired application would be particularly advantageous.

### SUMMARY OF THE INVENTION

In accordance with one embodiment of the present invention, a structural member is disclosed. The structural member includes a body portion and a locally reinforced portion. The body portion is formed from a long fiber thermoplastic material, the long fiber thermoplastic material including a plurality of long fibers dispersed in a thermoplastic resin. The locally reinforced portion is formed from a continuous fiber thermoplastic material overmolded by the long fiber thermoplastic material, the continuous fiber thermoplastic material including a plurality of continuous fibers dispersed in a thermoplastic resin.

In accordance with another embodiment of the present disclosure a method for forming a structural member is disclosed. The method includes providing a preform in a mold, the preform formed from a continuous fiber thermoplastic material, and providing a long fiber thermoplastic material into the mold. The method further includes curing the long fiber thermoplastic material. The preform is overmolded by the long fiber thermoplastic material, forming a locally reinforced portion of the structural member.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is a top view of an automobile underbody shield according to one embodiment of the present disclosure;

FIG. 2 is a bottom view of an automobile underbody shield according to one embodiment of the present disclosure;

FIG. 3 is a cross-sectional view of a locally reinforced portion of a structural member according to one embodiment of the present disclosure;

FIG. 4 is a cross-sectional view of a locally reinforced portion of a structural member according to another embodiment of the present disclosure;

FIG. 5 is a cross-sectional view of a locally reinforced portion of a structural member according to another embodiment of the present disclosure;

FIG. 6 is a cross-sectional view of a locally reinforced portion of a structural member according to another embodiment of the present disclosure;

FIG. 7 is a top view of one layer of a woven fabric preform according to one embodiment of the present disclosure;

FIG. 8 is a top view of one layer of a woven fabric preform according to another embodiment of the present disclosure;

FIG. 9 is a graph illustrating the absorption energy of various embodiments of long fiber thermoplastic materials and continuous fiber thermoplastic materials;

FIG. 10 is a graph illustrating the absorption energy of various embodiments of continuous fiber thermoplastic materials overmolded by direct long fiber thermoplastic materials; and

FIG. 11 illustrates a mold for forming a structural member according to one embodiment of the present disclosure.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a structural member having at least one locally reinforced portion. The structural member is in exemplary embodiments an automobile component, such as an underbody shield. The locally reinforced portion of the structural member is formed from a continuous fiber thermoplastic material that is overmolded by a long fiber thermoplastic material, which in exemplary embodiments is a direct long fiber thermoplastic material. The remainder of the structural member, characterized as one or more body portions thereof, is formed from a long fiber thermoplastic material. Thus, advantageously, the structural member may be relatively lightweight, due to the body portions being relatively lightweight and thin and having relatively low fiber weight percentages. Further, the locally reinforced portions may provide additional structural integrity to the structural member, particularly at target locations that are subjected to, for example, increased stress concentrations. Resulting structural members are thus relatively lightweight while maintaining suitable structural integrity for desired applications.

Relative energy absorption of the various portions of structural members according to the present disclosure is one indication of the relative structural integrity of the various portions. For example, a total energy absorption ratio of a locally reinforced portion to a body portion of a structural member according to the present disclosure may be in some embodiments greater than or equal to approximately 1.6 to 1.0, in some embodiments greater than or equal to approximately 1.8 to 1.0, in some embodiments greater than or equal to approximately 2.0 to 1.0, in some embodiments greater than or equal to approximately 2.2 to 1.0. Such relative energy absorption of locally reinforced portions according to the present disclosure thus provides desired structural integrity to the structural members. Relative thickness, weight fraction, and/or bulk density may additionally or alternatively be indicators of the relative structural integrity of the various portions.

Various embodiments of the present invention will now be described in more detail.

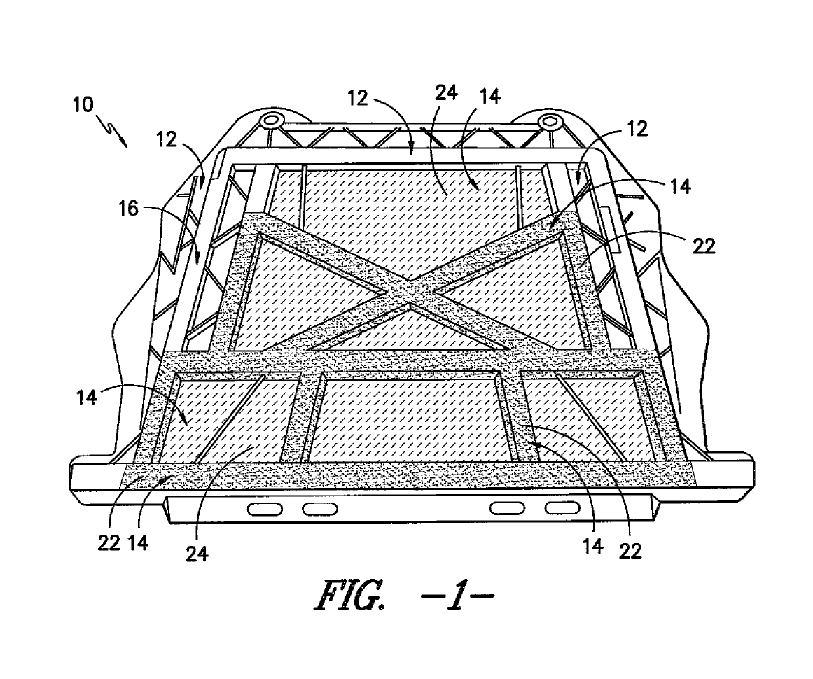

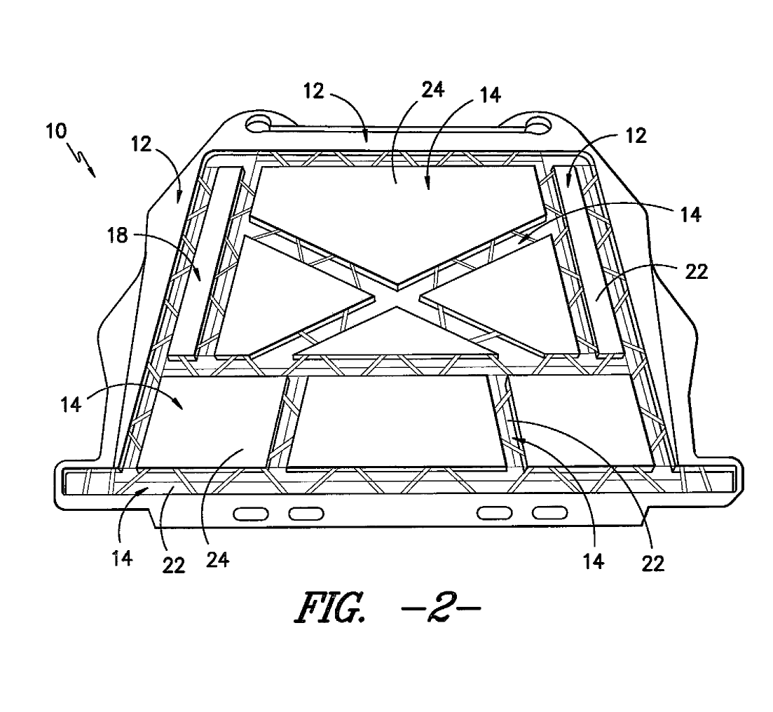

FIGS. 1 and 2 illustrate one embodiment of a structural member according to the present disclosure. In this embodiment, the structural member is an automobile component, and particularly an underbody shield 10. An automobile underbody shield 10 is a panel that is typically mechanically attached to the automobile to cover at least a portion of the underside of the automobile. In many cases, an underbody shield extends between the front and rear bumpers of the automobile, generally covering the underside of the automobile with the exception of the exhaust tunnel. During operation, the underbody shield is subjected to, and protects the automobile from, debris impingement and moisture and corrosion ingress. Further, and underbody shield may reduce noise, vibration, and harshness issues. It should be understood, however, that the present disclosure is not limited to underbody shields 10. For example, the structural member may in other embodiments be a bumper panel, door panel, front panel, or rear panel, or any other suitable automobile component. Further, structural members according to the present disclosure are not limited to automobile components, and rather include any suitable component that has local reinforcing portions therein.

A structural member, such as the underbody shield 10 as shown, thus includes one or more body portions 12 and one or more locally reinforced portions 14. Advantageously, the body portions 12 according to the present disclosure may be lightweight portions of the structural member, while the locally reinforced portions 14 provide suitable structural integrity to the structural member. As shown, a structural member may further include a first side surface 16 and an opposing second side surface 18.

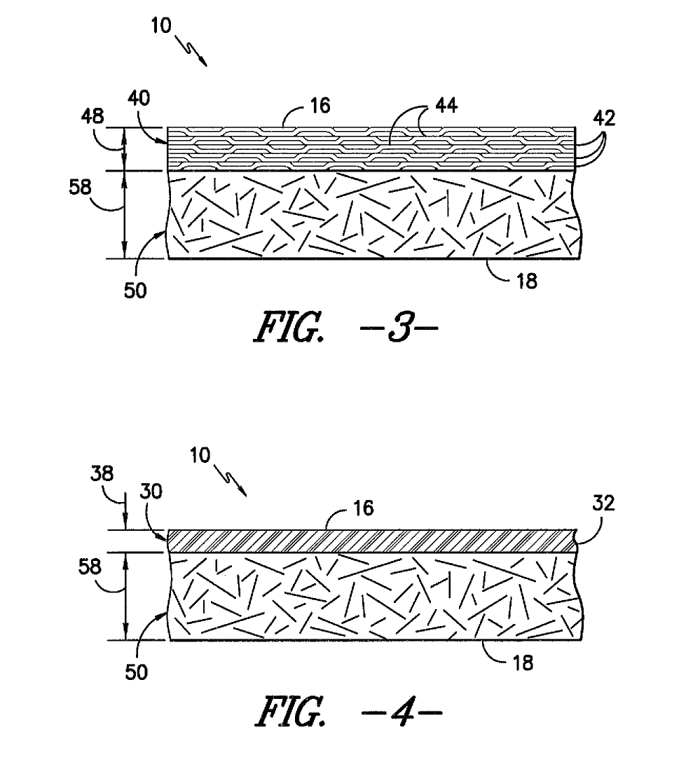

A locally reinforced portion 14 according to the present disclosure is a portion of the structural member that may require reinforcement for the structural component to endure operation in a particular environment, such as in some cases on an automobile. For example, locally reinforced portions 14 may be subjected to relatively higher stress concentrations during operation. Additionally or alternatively, locally reinforced portions 14 may be particularly susceptible to, for example, debris impingement or moisture and corrosion ingress, or may otherwise require local reinforcement. For example, as discussed, in some embodiments, the structural member may be an underbody shield 10. In these embodiments, a locally reinforced portion 14 may be a rib 22 of the underbody shield 10 or a center body portion 24 of the underbody shield 10, as shown in FIGS. 2 and 3.

A body portion 12 of a structural member according to the present disclosure is formed from a long fiber thermoplastic (“LFT”) material, which in exemplary embodiments is a direct long fiber thermoplastic (“D-LFT”) material. As used herein, the term “long fibers” generally refers to fibers, filaments, yarns, or rovings that are not continuous, and as opposed to “continuous fibers” which generally refer to fibers, filaments, yarns, or rovings having a length that is generally limited only by the length of a part. A long fiber thermoplastic material includes a plurality of long fibers dispersed in a thermoplastic resin. The fibers may be made by pultruding continuous fiber rovings, discussed below, and chopping them into pellets. In some embodiments, for example, the fiber length can equal the pellet length and generally can range from approximately 3 millimeters to approximately 25 millimeters. Preferred rovings and resulting long fibers contain a sizing system which is capable of chemically coupling to the thermoplastic resin. Any suitable device or apparatus may be utilized to form the long fiber thermoplastic material. For example, in embodiments wherein a direct long fiber thermoplastic material is utilized, the thermoplastic resin may be mixed with the long fibers in an extruder. A charge may be extruded and flowed or otherwise placed into a mold, such as a compression mold. The mold may then be closed and the materials allowed to cure, thus forming the component, in this instance the body portion 12.

A long fiber thermoplastic material according to the present disclosure may have any suitable weight fraction of fibers. For example, the weight fraction of fibers in the long fiber thermoplastic material may be in some embodiments from approximately 5% to approximately 50%, in some embodiments from approximately 10% to approximately 40%, in some embodiments from approximately 15% to approximately 30%, in some embodiments approximately 20%.

A body portion 12 formed from a long fiber thermoplastic material may have any suitable thickness, such as in some embodiments between approximately 0.1 mm and approximately 5 mm, such as approximately 1.0 mm, 1.5 mm, 2.0 mm, 2.5 mm, or 3.0 mm.

A locally reinforced portion 14 of a structural member according to the present disclosure is formed from a continuous fiber thermoplastic (“CFT”) material overmolded by a long fiber thermoplastic material, which in exemplary embodiments is the long fiber thermoplastic material utilized to form the body portion 12. A continuous fiber thermoplastic material includes a plurality of continuous fibers dispersed in a thermoplastic resin. To overmold the continuous fiber thermoplastic material, one or more preforms formed from the continuous thermoplastic material may be provided in a mold before the long fiber thermoplastic material is entered into the mold. The long fiber thermoplastic material may thus form around and bond with, and thus overmold, the continuous fiber thermoplastic material.

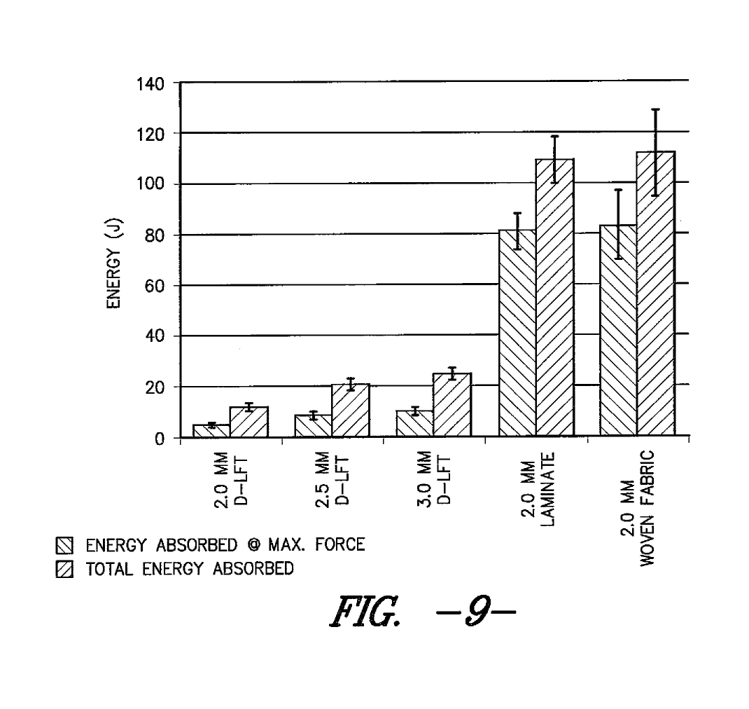

The continuous fiber thermoplastic material may in some embodiments form a laminate 30, as shown in FIGS. 4 through 6, or a woven fabric 40, as shown in FIGS. 3 and 5 through 8, and a single layer 42 of which is shown in FIGS. 7 and 8. The preform may in these embodiments thus be a laminate 30 or a woven fabric 40. Laminates 30 and woven fabrics 40 according to the present disclosure may, for example, be formed by impregnating a thermoplastic resin with a plurality of continuous fibers to form ravings, which may then be consolidated to form tapes, or plies, of continuous fiber thermoplastic material. The plies may then be woven or otherwise intertwined and/or consolidated into a laminate 30, woven fabric 40, or layer thereof.

For example, the thermoplastic resin may initially be extruded through a suitable extrusion device, and may then be provided into an impregnation die. Continuous fibers, such as rovings thereof, may be provided in the impregnation die and embedded in the thermoplastic resin. As used herein, the term “roving” generally refers to a bundle of individual fibers. The fibers contained within the roving can be twisted or can be straight. The rovings may contain a single fiber type or different types of fibers. Different fibers may also be contained in individual rovings or, alternatively, each roving may contain a different fiber type. The continuous fibers employed in the rovings may possess a high degree of tensile strength relative to their mass. For example, the ultimate tensile strength of the fibers is typically from about 1,000 to about 15,000 Megapascals (“MPa”), in some embodiments from about 2,000 MPa to about 10,000 MPa, and in some embodiments, from about 3,000 MPa to about 6,000 MPa. Such tensile strengths may be achieved even though the fibers are of a relatively light weight, such as a mass per unit length of from about 0.05 to about 3 grams per meter, in some embodiments from about 0.4 to about 1.5 grams per meter. The ratio of tensile strength to mass per unit length may thus be about 1,000 Megapascals per gram per meter (“MPa/g/m”) or greater, in some embodiments about 4,000 MPa/g/m or greater, and in some embodiments, from about 5,500 to about 20,000 MPa/g/m. The number of fibers contained in each roving can be constant or vary from roving to roving. Typically, a roving contains from about 1,000 fibers to about 50,000 individual fibers, and in some embodiments, from about 5,000 to about 30,000 fibers.

After exiting the impregnation die, the impregnated rovings, or extrudate, may be consolidated into the form of a tape, or ply. The number of rovings employed in a ply may vary. Typically, however, a ply will contain from 10 to 80 rovings, and in some embodiments from 20 to 50 rovings. In some embodiments, it may be desired that the rovings are spaced apart approximately the same distance from each other within the ply. In other embodiments, however, it may be desired that the rovings are combined, such that the fibers of the rovings are generally evenly distributed throughout the ply. In these embodiments, the rovings may be generally indistinguishable from each other.

After a ply is formed from the continuous fiber thermoplastic material, a plurality of narrower plies are formed, typically by cutting them from the original ply. These narrower plies may be utilized to form a preform, such as a laminate 30 or woven fabric 40. As shown in FIGS. 3 and 5 through 8, a woven fabric 40 according to the present disclosure is formed from a plurality of layers 42, each layer 42 including a plurality of plies 44 arranged to form the layer, such as by being interwoven together. Each layer 42 of plies may have any suitable arrangement. For example, in some embodiments as shown in FIG. 7, the plies in a layer 42 may have a 0 degree/90 degree orientation, with reference to a vertical axis extending across the plane of the layer 42. In other embodiments as shown in FIG. 8, the plies in a layer 42 may have a 45 degree/−45 degree orientation, with reference to the vertical axis. In still other embodiments, the plies in a layer 42 may have any suitable relative orientation.

Any suitable number of layers 42, such as 2, 3, 4 or more, may be utilized. Further, each layer 42 may have any suitable thickness, such as in some embodiments between approximately 0.1 mm and approximately 1 mm, such as approximately 0.5 mm. The resulting woven fabric 40 may further have any suitable thickness, such as in some embodiments between approximately 0.5 mm and approximately 5 mm, such as approximately 1 mm, 1.5 mm, or 2.0 mm.

As shown in FIGS. 4 through 6, a laminate 30 according to the present disclosure is formed from a single layer 32 that includes a plurality of plies (not shown) arranged to form the layer, such as by being interwoven and consolidated together. The layer 32 of plies may have any suitable arrangement. For example, in some embodiments, the plies in the layer 32 may have a 0 degree/90 degree orientation, with reference to a vertical axis extending across the plane of the layer 32. In other embodiments, the plies in a layer 32 may have a 0 degree/90 degree/45 degree/−45 degree orientation, with reference to the vertical axis. In still other embodiments, the plies in the layer 32 may have any suitable relative orientation.

The resulting single layer 32 laminate 30 may further have any suitable thickness, such as in some embodiments between approximately 0.5 mm and approximately 5 mm, such as approximately 1 mm, 1.5 mm, or 2.0 mm.

A continuous fiber thermoplastic material according to the present disclosure may have any suitable weight fraction of fibers. For example, the weight fraction of fibers in the continuous fiber thermoplastic material may be in some embodiments from approximately 50% to approximately 90%, in some embodiments from approximately 60% to approximately 80%, in some embodiments approximately 70%.

A thermoplastic resin according to the present disclosure is formed from any suitable thermoplastic material. Suitable thermoplastics for use in the present invention may include, for instance, polyolefins (e.g., polypropylene, propylene-ethylene copolymers, etc.), polyesters (e.g., polybutylene terephalate (“PBT”)), polycarbonates, polyamides (e.g., Nylon™), polyether ketones (e.g., polyetherether ketone (“PEEK”)), polyetherimides, polyarylene ketones (e.g., polyphenylene diketone (“PPDK”)), liquid crystal polymers, polyarylene sulfides (e.g., polyphenylene sulfide (“PPS”)), fluoropolymers (e.g., polytetrafluoroethylene-perfluoromethylvinylether polymer, perfluoro-alkoxyalkane polymer, petrafluoroethylene polymer, ethylene-tetrafluoroethylene polymer, etc.), polyacetals, polyurethanes, polycarbonates, styrenic polymers (e.g., acrylonitrile butadiene styrene (“ABS”)), and so forth. Polypropylene and polyethylene are particularly suitable for applications according to the present disclosure.

The fibers dispersed in the thermoplastic resin to form a long fiber thermoplastic material or continuous fiber thermoplastic material may be formed from any conventional material known in the art, such as metal fibers, glass fibers (e.g., E-glass, A-glass, C-glass, D-glass, AR-glass, R-glass, S1-glass, S2-glass), carbon fibers (e.g., graphite), boron fibers, ceramic fibers (e.g., alumina or silica), aramid fibers (e.g., Kevlar® marketed by E. I. duPont de Nemours, Wilmington, Del.), synthetic organic fibers (e.g., polyamide, polyethylene, paraphenylene, terephthalamide, polyethylene terephthalate and polyphenylene sulfide), and various other natural or synthetic inorganic or organic fibrous materials known for reinforcing polymer compositions. Glass fibers and carbon fibers are particularly desirable for use in applications according to the present disclosure.

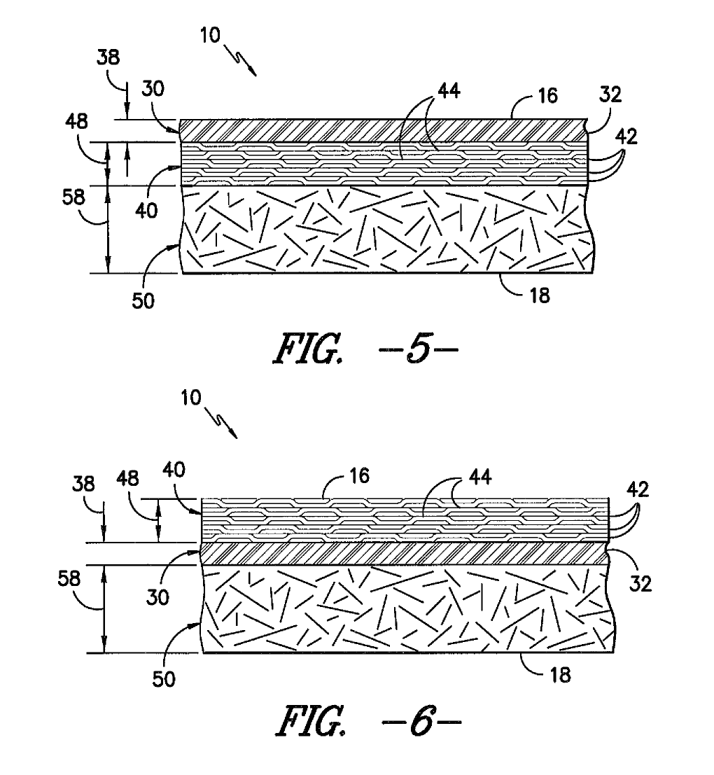

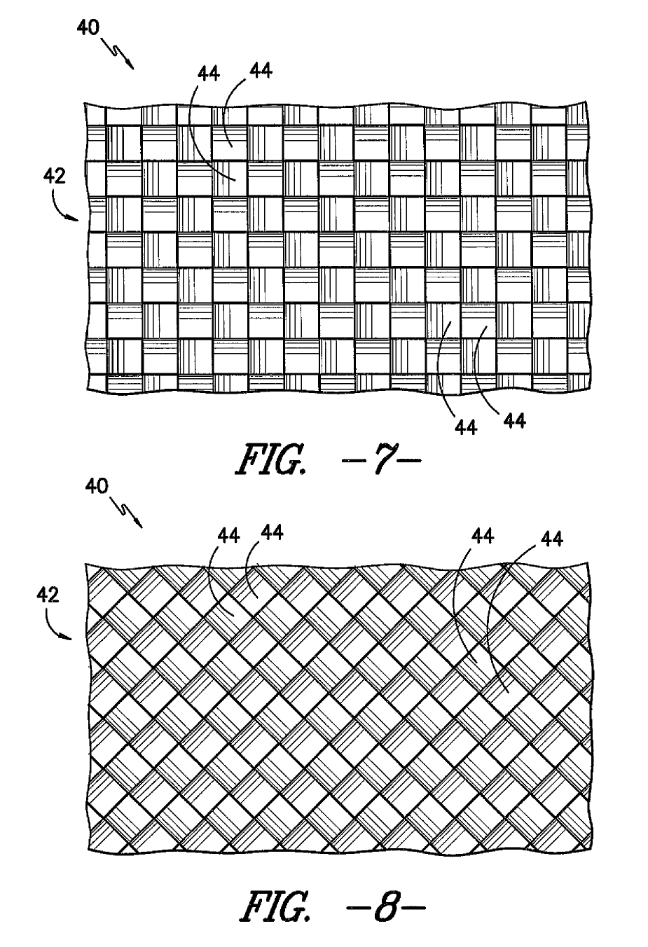

FIGS. 3 through 6 illustrate cross-sectional views of various embodiments of locally reinforced portions 14 according to the present disclosure. As discussed, each locally reinforced portion 14 includes a continuous fiber thermoplastic material overmolded by a long fiber thermoplastic material. The continuous fiber thermoplastic material may be in the form of a laminate 30 and/or a woven fabric 40. For example, FIG. 3 illustrates one embodiment of a locally reinforced portion 14, wherein the locally reinforced portion 14 includes a woven fabric 40 overmolded by a long fiber thermoplastic material layer 50. FIG. 4 illustrates one embodiment of a locally reinforced portion 14, wherein the locally reinforced portion 14 includes a laminate 30 overmolded by a long fiber thermoplastic material layer 50. FIGS. 5 and 6 illustrate one embodiment of a locally reinforced portion 14, wherein the locally reinforced portion 14 includes a woven fabric 40 and a laminate 30 overmolded by a long fiber thermoplastic material layer 50. In the embodiment as shown in FIG. 5, a laminate 30 is placed in a mold, and a woven fabric 40 is placed on the laminate 30. The long fiber thermoplastic material is then overmolded over the woven fabric 40 and laminate 30. In the embodiment as shown in FIG. 6, a woven fabric 40 is placed in a mold, and a laminate 30 is placed on the woven fabric 40. The long fiber thermoplastic material is then overmolded over the woven fabric 40 and laminate 30. Respective thicknesses 38, 48, 58 of the respective laminate 30, woven fabric 40, and long fiber thermoplastic material layer 50 are shown.

As discussed, relative energy absorption of the various portions of structural members according to the present disclosure is one indication of the relative structural integrity of the various portions. For example, a total energy absorption ratio of a locally reinforced portion 14 to a body portion 12 of a structural member according to the present disclosure may be in some embodiments greater than or equal to approximately 1.6 to 1.0, in some embodiments greater than or equal to approximately 1.8 to 1.0, in some embodiments greater than or equal to approximately 2.0 to 1.0, in some embodiments greater than or equal to approximately 2.2 to 1.0. Such relative energy absorption of locally reinforced portions 14 according to the present disclosure thus provides desired structural integrity to the structural members.

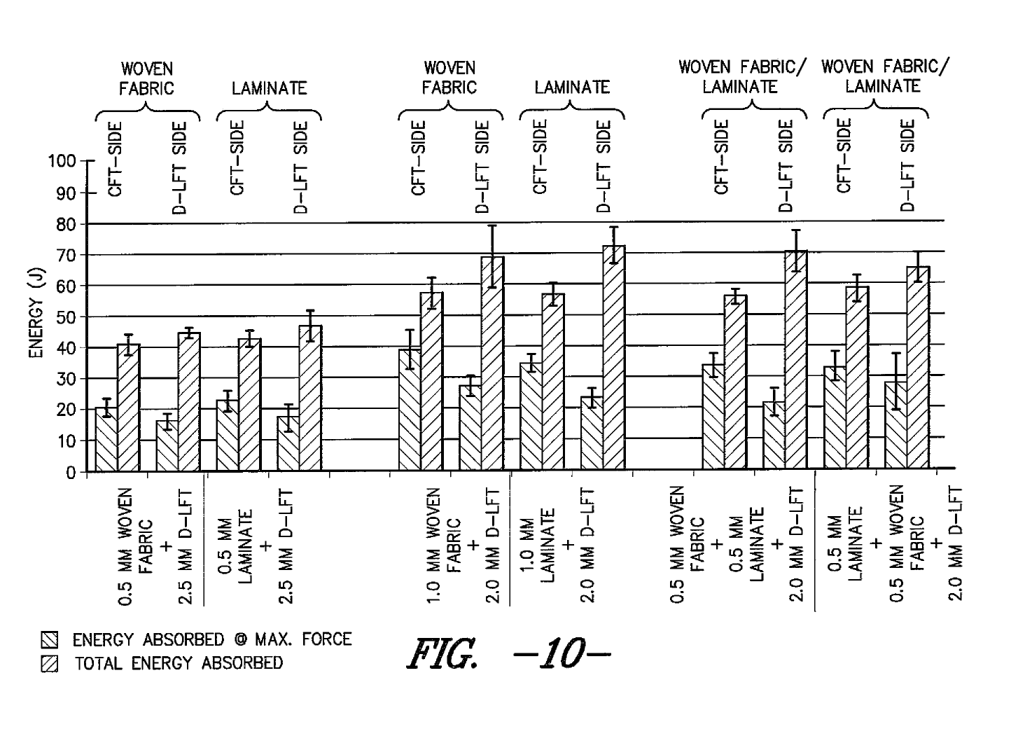

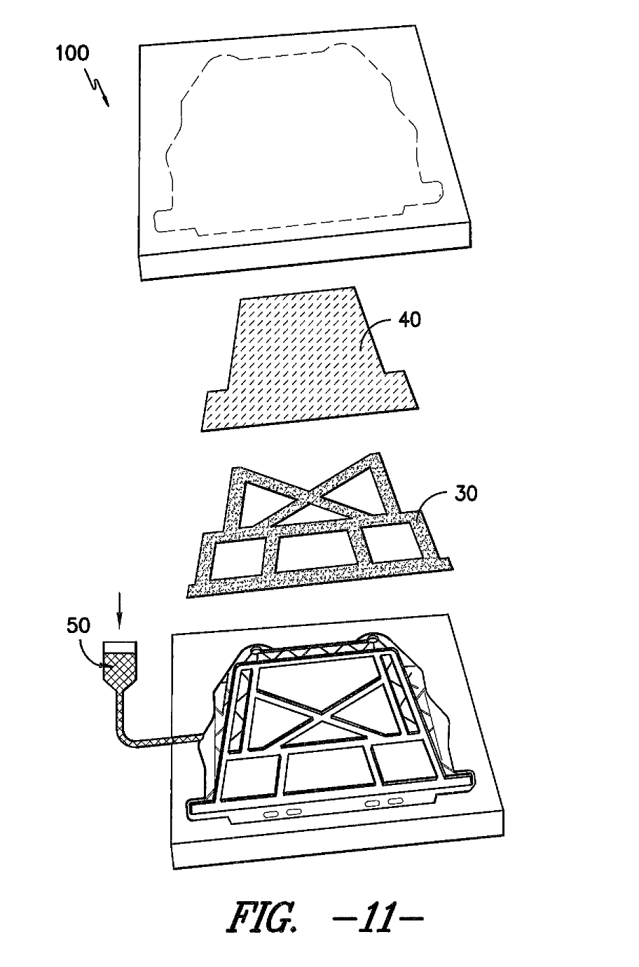

FIGS. 9 and 10 are graphs of energy absorption of various materials utilized according to the present disclosure. Both relative absorbed energy at a maximum force, as well as total energy absorbed, is shown. The long fiber thermoplastic material utilized included glass fibers embedded in polypropylene. The continuous long fiber thermoplastic material utilized to form laminates and woven fabrics included glass fibers embedded in polypropylene. FIG. 9 illustrates energy absorption of various thicknesses of samples of the various materials alone. FIG. 10 illustrates energy absorption of various thicknesses of sample locally reinforced portions 14 having various configurations of the various materials. As indicated in the graph shown in FIG. 10, energy absorption testing was performed and is shown for both a continuous fiber thermoplastic material side and a direct long fiber thermoplastic material side, which may be for example a respective top first side surface 16 and opposing second side surface 18 or vice versa of a locally reinforced portion 14.

Structural members formed according to the present disclosure may have many further advantages in terms of relative characteristics of body portions 12 versus locally reinforced portions 14. For example, due to the structural advantages facilitated by the locally reinforced portions 14, the thickness of a body portion 12 may be reduced relative to a locally reinforced portion 14. For example, a thickness ratio of a locally reinforced portion 14 to a body portion 12 may be in some embodiments greater than or equal to approximately 1 to 1, in some embodiments greater than or equal to approximately 1.2 to 1, in some embodiments greater than or equal to approximately 1.4 to 1, in some embodiments greater than or equal to approximately 1.6 to 1, in some embodiments greater than or equal to approximately 1.8 to 1, in some embodiments greater than or equal to approximately 2 to 1. Further, the weight fraction of a body portion 12 may be reduced relative to a locally reinforced portion 14. For example, a weight fraction ratio of a locally reinforced portion 14 to a body portion 12 may be in some embodiments greater than or equal to approximately 1.6 to 1, in some embodiments greater than or equal to approximately 2.2 to 1, in some embodiments greater than or equal to approximately 2.8 to 1, in some embodiments greater than or equal to approximately 3.4 to 1. Still further, the bulk density of a body portion 12 may be reduced relative to a locally reinforced portion 14.

The present disclosure is further directed to methods for forming a structural member, such as an automobile component, as shown for example, in FIG. 11. The method may include, for example, providing one or more preforms in a mold 100, which may be for example a compression mold or any other suitable mold. A preform may be formed from a continuous fiber thermoplastic material, and may be, for example, a laminate 30 or woven fabric 40. The preforms may be locally provided in locations to become locally reinforced portions 14. The method may further include providing a long fiber thermoplastic material into the mold 100, and curing the long fiber thermoplastic material. The preform may thus be overmolded by the long fiber thermoplastic material.

In some embodiments, the method may further include heating a preform. Heating of the preform before inserting into the mold 100 and/or flowing the long fiber thermoplastic material into the mold 100 may further facilitate bonding of the continuous fiber thermoplastic material and the long fiber thermoplastic material. The preform may be heated to, for example, greater than or equal to approximately 300° C., such as greater than or equal to approximately 350° C.

In some embodiments, the method may further include forming a preform. Preforms may be weaved or otherwise interweaved and/or consolidated, as discussed above.

The present invention may be better understood with reference to the following examples.

### EXAMPLE 1

Impact testing of various samples that included direct long fiber thermoplastic material alone and combined with woven fabric and/or laminate materials was performed. A 30% weight fraction direct long fiber thermoplastic material was formed, which included glass fibers embedded in a polypropylene resin via inline compounding (resin: PP-C711-70 RNA from Dow Chemical; additives package: Priex brand 20078 coupling agent for improved impact performance and AddVance brand 453 stabilizer package, both from Addcomp Holland BV) (glass fiber: JM 490 2400 tex glass from Johns Manville). 70% weight fraction continuous fiber thermoplastic material plies were formed, which included glass fibers embedded in a polypropylene resin (Ticona Celstran CFR-TP PP-GF70). The plies were 20 mm wide and 0.25 mm thick. In turn, the plies were used to produce laminates and woven fabrics. Laminates were made by FiberForge in several layup patterns (each ply was 0.25 mm thick): a 0°/90° configuration (0/90) in a single preconsolidated sheet with the following thicknesses: 0.5, 1.0, 1.5, and 2.0 mm; and in a quasi-isotropic configuration ((0,90,+45,−45)ₛ (where “s” represents number of layers of laminate symmetry)). Fabrics were Oxeon Textreme brand, using 20 mm wide, 0.25 mm thick plies. The fabrics were produced in two configurations: plies were laid up in either a 0°/90° (0/90) or a ±45° configuration (45/−45) for a total thickness of 0.50 mm.

A ZSE-60 G1500 32D inline compounding system was used in combination with a ZSG-75 HP300 mixing extruder, both from Leistritz, and a dosing unit from Brabender. The whole system was supplied by Dieffenbacher and was in turn coupled with a Dieffenbacher 36,000-kN Compress Plus DCP-G 3600/3200 AS hydraulic compression press equipped with parallel leveling control. Molding pressure was approximately 3,200 kN.

Woven fabrics and laminate preforms were heated prior to stacking and co-molding them with the direct long fiber thermoplastic material charge. An infrared oven (with a set temperature of 350° C.) was used to preheat the reinforcing materials. Heating time in the oven was dependent on wall thickness of materials involved.

For samples utilizing woven fabrics, several layers were heated next to each other inside the oven. The layers were then stacked on top of each other (without applying any additional pressure) to achieve a full-thickness preform, and the preform was transferred to the mold. For samples utilizing laminates, the single layer laminate preforms were heated in the oven and transferred to the mold. After the direct long fiber thermoplastic material charge was introduced into the mold, and the mold compressed, samples had a dwell time in the tool of approximately 45 sec before being demolded.

Six test coupons were milled from each sample in the section where the direct long fiber thermoplastic material charge had been placed. Five of these coupons were subjected to mechanical testing (with a sixth sample being kept back as a control). Specimen removal and preparation steps followed standard test protocols. Impact testing was conducted on a CEAST Fractovis testing machine using a Type C clamping device with a 40-mm inner diameter. The machine impacted the samples at a speed of 4.4 m/sec at 23° C. The impact was made with a hemispherical-shaped impactor with a diameter of 20 mm.

Results of the impact testing are shown in FIGS. 9 and 10.

### EXAMPLE 2

An automobile underbody shield was formed. A 20% weight fraction direct long fiber thermoplastic material was formed, which included glass fibers embedded in a polypropylene resin via inline compounding (resin: PP-C711-70 RNA from Dow Chemical; additives package: Priex brand 20078 coupling agent for improved impact performance and AddVance brand 453 stabilizer package, both from Addcomp Holland BV) (glass fiber: JM 490 2400 tex glass from Johns Manville). 70% weight fraction continuous fiber thermoplastic material plies were formed, which included glass fibers embedded in a polypropylene resin (Ticona Celstran CFR-TP PP-GF70). The plies were 20 mm wide and 0.25 mm thick. In turn, the plies were used to produce laminates and woven fabrics. Laminates were made by FiberForge in several layup patterns (each ply was 0.25 mm thick): a 0°/90° configuration (0/90) in a single preconsolidated sheet with the following thicknesses: 0.5, 1.0, 1.5, and 2.0 mm; and in a quasi-isotropic configuration ((0,90,+45,−45)s (where “s” represents number of layers of laminate symmetry)). Fabrics were Oxeon Textreme brand, using 20 mm wide, 0.25 mm thick plies. The fabrics were produced in two configurations: plies were laid up in either a 0°/90° (0/90) or a ±45° configuration (45/−45) for a total thickness of 0.50 mm.

A ZSE-60 GI500 32D inline compounding system was used in combination with a ZSG-75 HP300 mixing extruder, both from Leistritz, and a dosing unit from Brabender. The whole system was supplied by Dieffenbacher and was in turn coupled with a Dieffenbacher 36,000-kN Compress Plus DCP-G 3600/3200 AS hydraulic compression press equipped with parallel leveling control. Molding pressure was approximately 12,000 kN.

Woven fabrics and laminate preforms were heated prior to stacking and co-molding them with the direct long fiber thermoplastic material charge. An infrared oven (with a set temperature of 350° C.) was used to preheat the reinforcing materials. Heating time in the oven was dependent on wall thickness of materials involved. The preforms were transferred to the mold. Woven fabric preforms were utilized for center body portions and ribs of the underbody shield, and laminate preforms were utilized for ribs of the underbody shield. After the direct long fiber thermoplastic material charge was introduced into the mold, and the mold compressed, the underbody shield had a dwell time in the tool of approximately 40 sec before being demolded.

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. An automobile component, comprising:
a body portion formed from a long fiber thermoplastic material, the long fiber thermoplastic material comprising a plurality of long fibers dispersed in a thermoplastic resin; and
a locally reinforced portion formed from a continuous fiber thermoplastic material overmolded by the long fiber thermoplastic material, the continuous fiber thermoplastic material comprising a plurality of continuous fibers dispersed in a thermoplastic resin.

2. The automobile component of claim 1, wherein a total energy absorption ratio of the locally reinforced portion to the body portion is greater than or equal to approximately 1.6 to 1.

3. The automobile component of claim 1, wherein a thickness ratio of the locally reinforced portion to the body portion is greater than or equal to approximately 1 to 1.

4. The automobile component of claim 1, wherein a weight fraction ratio of the continuous fiber thermoplastic material to the long fiber thermoplastic material is greater than or equal to approximately 2.2 to 1.

5. The automobile component of claim 1, wherein the thermoplastic resin of the long fiber thermoplastic material and the continuous fiber thermoplastic material is polypropylene.

6. The automobile component of claim 1, wherein the long fiber thermoplastic material is a direct long fiber thermoplastic material.

7. The automobile component of claim 1, wherein the plurality of long fibers are glass fibers.

8. The automobile component of claim 1, wherein the long fiber thermoplastic material has a weight fraction of between approximately 10% and approximately 40%.

9. The automobile component of claim 1, wherein the plurality of continuous fibers are glass fibers.

10. The automobile component of claim 1, wherein the continuous fiber thermoplastic material has a weight fraction of between approximately 60% and approximately 80%.

11. The automobile component of claim 1, wherein the continuous fiber thermoplastic material forms a woven fabric, the fabric overmolded by the long fiber thermoplastic material, the fabric comprising a plurality of continuous fiber thermoplastic plies arranged in a plurality of layers.

12. The automobile component of claim 11, wherein at least one layer of the fabric comprises a plurality of plies arranged in a 0 degree/90 degree configuration.

13. The automobile component of claim 11, wherein at least one layer of the fabric comprises a plurality of plies arranged in a −45 degree/45 degree configuration.

14. The automobile component of claim 1, wherein the continuous fiber thermoplastic material forms a laminate, the laminate overmolded by the long fiber thermoplastic material, the laminate comprising a plurality of continuous fiber thermoplastic plies arranged in a single layer.

15. The automobile component of claim 1, wherein the automobile component is an underbody shield.

16. The automobile component of claim 1, wherein the locally reinforced portion is a rib.

17. The automobile component of claim 1, wherein the locally reinforced portion is a center body portion.

18. The automobile component of claim 1, wherein the locally reinforced portion is a plurality of locally reinforced portions.

19. A structural member, comprising:
a body portion formed from a long fiber thermoplastic material, the long fiber thermoplastic material comprising a plurality of long fibers dispersed in a thermoplastic resin; and
a locally reinforced portion formed from one of a woven fabric or a laminate overmolded by the long fiber thermoplastic material, the one of the woven fabric or the laminate formed from a continuous fiber thermoplastic material, the continuous fiber thermoplastic material comprising a plurality of continuous fibers dispersed in a thermoplastic resin.

20. A method for forming an automobile component, comprising:
providing a preform in a mold, the preform formed from a continuous fiber thermoplastic material;
providing a long fiber thermoplastic material into the mold; and
curing the long fiber thermoplastic material, wherein the preform is overmolded by the long fiber thermoplastic material, forming a locally reinforced portion of the automobile component, and wherein a total energy absorption ratio of the locally reinforced portion to a body portion of the automobile component is greater than or equal to approximately 1.6 to 1.

21. The method of claim 20, further comprising heating the preform.

22. The method of claim 20, wherein the preform is a woven fabric comprising a plurality of continuous fiber thermoplastic plies arranged in a plurality of layers.

23. The method of claim 20, wherein the preform is a laminate comprising a plurality of continuous fiber thermoplastic plies arranged in a single layer.

24. The method of claim 20, wherein a total energy absorption ratio of the locally reinforced portion to the body portion is greater than or equal to approximately 1.6 to 1.

25. The method of claim 20, wherein a thickness ratio of the locally reinforced portion to the body portion is greater than or equal to approximately 1 to 1.

26. The method of claim 20, wherein a weight fraction ratio of the continuous fiber thermoplastic material to the long fiber thermoplastic material is greater than or equal to approximately 2.2 to 1.
